(19) United States
(12) Patent Application Publication
(10) Pub. No.: US 2024/0175632 A1
(43) Pub. Date: May 30, 2024

(54) HEATING DEVICE FOR A ROD-SHAPED WORKPIECE

(71) Applicant: EXTRUTEC GMBH, Moos (DE)

(72) Inventors: Uwe Günter, Gaienhofen (DE); Joachim Sokoll, Volkertshausen (DE); Stefan Beer, Menden (DE)

(73) Assignee: EXTRUTEC GMBH, Moos (DE)

(21) Appl. No.: 18/284,144

(22) PCT Filed: Feb. 16, 2022
(86) PCT No.: PCT/EP2022/053806

§ 371 Date: Sep. 26, 2023

(30) Foreign Application Priority Data
Mar. 26, 2021 (DE) 10 2021 107 670.6

(51) Int. Cl. F27B 9/36; F27B 9/20; F27B 9/24; F27B 9/30; H05B 6/10

(52) U.S. Cl. CPC F27B 9/36; F27B 9/208; F27B 9/24; F27B 9/3005; H05B 6/102

(57) ABSTRACT

The invention relates to a heating device (1), in particular an in-line heater, for heating rod-shaped, electroconductive workpieces (13), in particular metal rods and/or non-ferrous metal rods which are conveyed along a conveying direction (R) through the heating device (1), the heating device (1) having a first heating module (2) in relation to the conveying direction (R), the first heating module (2) having a first input area (4) and a first output area (5), and a second heating module (3) in relation to the conveying direction (R), the second heating module (3) having a second input area (6) and a second output area (7).

### BACKGROUND OF THE INVENTION

The present invention relates to a heating device for heating rod-shaped, electroconductive workpieces, such as metal rods and/or non-ferrous metal rods in the preferred embodiment of aluminum rods.

Heating devices for rod-shaped, electroconductive workpieces are generally known from the state of the art. For example, EP 2 337 871 B1 describes a generic heating device, referred to as in-line heater, for rod-shaped, electroconductive workpieces, which pass through the heating device along a conveying direction and which initially pass a first heating module for a preheating and which subsequently pass a second heating module for a final heating with a higher thermal output.

The preheating realized in the first heating module is effected by means of a conventional gas oven, in which the flames resulting from burning the gas are used directly for heating the workpiece. For realizing the second heating module, the generic heating device comprises an induction module, which comprises power coils for generating eddy currents in the workpiece to be heated, the power coils extending along the conveying direction of the workpiece. Though the gas oven and the induction module form a continuous heating chamber for the workpiece, they must have a thermal decoupling portion for preventing flames from spreading between the gas oven and the induction module in order to prevent damage to the induction module caused by the spreading flames. This is disadvantageous in that the decoupling portion causes the heating device to increase in length and thus increases the structural effort for producing the heating device. Additionally, the rod-shaped workpieces lose heat that has already been introduced despite an extensive thermal insulation, which causes additional expenses, when passing through the coupling portion, which is why the overall efficiency of the heating device also decreases because of the thermal loss occurring in the decoupling portion.

### SUMMARY OF THE INVENTION

Therefore, the object of the present invention is to propose a heating device which overcomes the disadvantages known from the state of the art. In particular, it is the object of the present invention to propose a heating device which, is compact in relation to the length and which can be easily produced in terms of structure, for efficiently heating the rod-shaped, electroconductive workpieces prior to an immediately following mechanical process by means of a pressing process.

This object is attained by a heating device having the features disclosed herein.

Advantageous embodiments of the invention are as disclosed herein and indicated in the dependent claims. The invention relates to all combinations comprising at least two characteristics disclosed in the description, the claims and/or the figures.

The present invention provides a heating device for heating rod-shaped, electroconductive workpieces, in particular metal rods and/or non-ferrous metal rods, such as aluminum rods, which can be conveyed along a conveying direction through the heating device, said heating device comprising a first heating module in relation to the conveying direction, the first heating module having a first input area and a first output area, and a second heating module in relation to the conveying direction, the second heating module having a second input area and a second output area, the second heating module being configured as an induction module for inductively heating the electroconductive workpiece.

Furthermore, according to the invention, the first heating module is configured as a convection module having heating mediums, the convection module being designed and configured such that a working gas can circulate between the heating mediums and the workpiece to be heated in order to initially heat the working gas using the heating mediums and then have the working gas flow against the workpiece to introduce a thermal output. According to the invention, it is additionally intended that the first output area is structurally disposed directly on the second input area, which results in an advantageous decrease in the length of the heating device according to the invention in order to form an energy-efficient and structurally compact heating device. Furthermore, the component cost can thus be reduced because a decoupling portion, which is customary in the state of the art, is not required.

In other words, by structurally disposing the first output area directly on the second input area, the length of the heating device according to the invention can be shortened. This is advantageously made possible according to the invention since no decoupling portion is required for the present heating device according to the invention, since controlling the temperature by means of the working gas does not result in the formation of flames. In addition to shortening the length, this also results in an improved overall efficiency of the heating device, since there is no loss of temperature in the workpiece when it passes through the decoupling portion. Furthermore, by eliminating the decoupling portion, the structural effort can be reduced.

By the first heating module being realized according to the invention as a convection module according to the invention having the heating mediums, heating the workpiece is only effected by means of the working gas which circulates between the workpiece to be heated and the heating mediums, said working gas having been heated by means of the heating mediums. Advantageously, flames can be fully prevented from forming in the first heating module, which is why the second heating module can be structurally disposed directly next to the first heating module. Thus, the decoupling portion is completely eliminated. Furthermore, the temperature of the working gas in the convection module according to the invention can be precisely controlled and adjusted via the heating mediums, which is why, in turn, the thermal output which can be introduced to the workpiece can be controlled precisely.

According to an embodiment of the present invention, the heating mediums are configured as a gas burner, preferably a recuperative burner, and as an electrical resistance heating element, preferably a resistance-heated heating register. Advantageously, this is realized by a hybrid convection module in order to heat the circulating working gas either classically using a fuel, in particular fossil fuel, i.e., gas in the present invention, or by means of electric energy. Advantageously, this leads to a wide range of application for the heating device to enable operation irrespective of a fossil fuel, in particular gas.

Another embodiment of the heating device according to the invention intends that the convection module comprises ventilation ducts for guiding the working gas, the ventilation ducts being designed such that the air which has been heated in the heating mediums can be guided to the workpiece as evenly as possible and without any large temperature loss, in order for the heated working gas to flow against the workpiece as extensively as possible and to thus realize a high heat input into the workpiece. Additionally, the ventilation ducts allow a structural separation between the supply air, which acts on the workpiece, and the exhaust air of the working gas to prevent that the heated working gas present before flowing against the workpiece comes into contact with the working gas which has already cooled down after flowing against the workpiece.

Furthermore, the configuration of the ventilation ducts allows a circuit for the working gas to be formed to efficiently heat the workpiece by means of the working gas, which has been heated multiple times via the circulation with the heating mediums and which has thus already been preheated.

Another embodiment provides that the convection module comprises gas-conveying elements, in particular a ventilator or a fan, for controlling and/or affecting an average flow rate of the working gas, in particular when said working gas flows through the ventilation ducts.

Advantageously, the gas-conveying elements can additionally control and affect the heating process of the workpieces since the flow rate of the working gas can be affected when the working gas flows against the workpiece and thus the flow rate can be increased in order to realize the highest possible heat input into the workpiece.

Furthermore, the working gas is at least partly sucked in by the gas-conveying elements, preferably after the working gas has flowed against and around the workpiece in order to be heated again by the heating mediums to a flow temperature between 730° C. to 750° C. and to thus realize a high system efficiency. Preferably, the gas-conveying elements also allow adjusting the average flow rate of the working gas to the temperature difference between the heating mediums and the workpiece in a targeted manner in order to implement individual temperature profiles in accordance with different material properties of the workpiece, for example the thermal diffusivity, or different diameters of the rod-shaped workpiece.

In the context of the present invention, another embodiment provides that the convection module comprises a control unit for controlling an operating mode of the gas burner and of the electrical resistance heating element, the control unit being formed such that, depending on user-generated and/or parameter-generated input signals, only the gas burner is activable in a first operating mode, only the electrical resistance heating element is activable in a second operating mode, and the gas burner and the electrical resistance heating element for heating des working gas are activable simultaneously in a third operating mode.

In the context of the present invention, user-generated input signals are understood to mean the selection of the operating modes of the heating mediums by an operator. For example, it is intended in this context that the operator only selects the gas burner as a heating medium for the entire heating process of the workpiece using the heating device according to the invention, only the working gas, which is hot exhaust air which has previously been heated by the gas burner, flowing against the workpiece when said workpiece passes through the first heating module. Advantageously, this reduces the required electric energy for the heating device which is required for heating the workpiece since the first heating module can also be operated by means of gas as the source of energy.

Alternatively, selecting the operating modes can also be effected in a parameter-generated manner, a communication link existing between the control unit and a communication partner in this context, in order to allow an automated activation of the operating modes on the basis of data, such as the proportion of renewable energies in the latest generation of electricity, or current energy costs, for example the latest electricity price (instantaneous value) in relation to costs for a fossil source of energy. Thus, for example when there is a surplus of renewable energy, a large portion of the thermal energy can be generated based on resistance, i.e., solely conductively, in order to profit from low electricity prices. Advantageously, the present embodiment thus also allows an optimized operation in order to realize the reduction of not only the operational costs but also CO2 and impending financial penalties from a technical point of view. Particularly advantageously, the preferred embodiment of the heating mediums as a gas burner can also realize an operation using hydrogen produced from renewable energy in order to also enable a CO2-free operation of the heating device when using the gas burner.

Another embodiment provides that the convection module comprises nozzle elements for affecting the average flow rate of the working gas when it strikes the rod-shaped workpiece.

Advantageously, the nozzle elements allow maximizing the heat input into the workpiece since the flow rate of the working gas can be affected in a targeted manner and thus be optimized immediately before said working gas flows against the workpiece. This preferred embodiment also synergistically reduces the total length of the heating device according to the invention because the heat input into the workpiece can be maximized when the workpiece is conveyed at a constant speed.

In this context, the nozzle elements are particularly preferably configured as a plurality of slot nozzles which are disposed adjacent to each other in the conveying direction of the workpiece and which extend laterally, in particular in sections, to the rod-shaped workpiece to be conveyed. The plurality of slot nozzles conducts the heated working gas on the radial side of the rod-shaped workpiece to the lateral surface of the workpiece in order to realize a large and thus optimal inflow in relation to the heat input. The fan-like slot nozzles are formed by v-shaped wall portions in order to realize an average flow rate of the working gas of up to 50 m/s. The preferred embodiment of the nozzle elements as the plurality of slot nozzles can also reduce the total length of the heating device in order to achieve the compact length according to the invention for the heating device.

Furthermore, the first heating module comprises at least two heating zones having a first convection module and at least a second convection module. Advantageously, this allows an independent adjustment of the temperature along the length of the heating device in the conveying direction in order to heat the temperature of the working gas, in particular to a value within the range of 730° C. to 750° C., and to thus control the temperature of the workpiece within the range of 380° C. to 450° C. Preferably, a high temperature gradient is used between the heated working gas and the (not yet tempered) workpiece as early as in the first heating zone in order to realize a high temperature gradient and to thus maximize the heat input into the workpiece. Advantageously, this contributes to the length of the heating device being able to be minimized. Furthermore, it is alternatively preferably intended that the temperature in the different heating zones can be controlled individually in order to realize, for example, an axial temperature profile, in particular a gradual temperature increase.

In this context, another embodiment provides that the induction module also has at least two independently controllable heating zones having a first induction module and at least a second induction module. This also makes it possible to apply an axial temperature profile to the rod-shaped workpiece in order to implement an individual heating characteristic depending on the geometry of the rod-shaped workpiece and/or depending on the material composition of the workpiece.

Another embodiment also provides that the first heating module and the second heating module are designed such that the conveying direction in the first heating module and the conveying direction in the second heating module extend along a shared longitudinal axis; in other words, this means that the heating device extends along a straight line. Advantageously, this facilitates the structural realization of the heating device since the workpieces are to be conveyed only transversely, i.e., along a shared extension axis, when they pass through the heating device.

Finally, one embodiment of the heating device is particularly preferred in which the first heating module comprises a length between 6 m to 15 m, preferably 6 m to 12 m, particularly preferably 6 m to 10 m, in the conveying direction, and in which the second heating module comprises a length between 0.5 m to 4 m, preferably 0.8 m to 2 m, particularly preferably 08 m to 1.6 m, in the conveying direction.

The details of the heating device illustrate the compact dimensions of the heating device according to the invention which allows the workpiece to be heated efficiently in a hybrid manner and which is characterized by a compact length.

### BRIEF DESCRIPTION OF THE DRAWINGS

Further advantages and details of the invention can be derived from the description of preferred embodiments of the invention below and by means of merely schematic drawings.

FIG. 1: is a heating device according to the invention according to a first embodiment,

FIG. 2: is a heating device according to the invention according to a second embodiment,

FIG. 3: is a sectional view of the heating device known from FIG. 1 according to the first embodiment,

FIG. 4: is a perspective view of the heating device according to the invention according to the first embodiment and

FIG. 5: is a perspective view of the heating device according to the invention according to the second embodiment.

In the figures, the same elements and elements having the same function are marked with the same reference signs.

### DETAILED DESCRIPTION

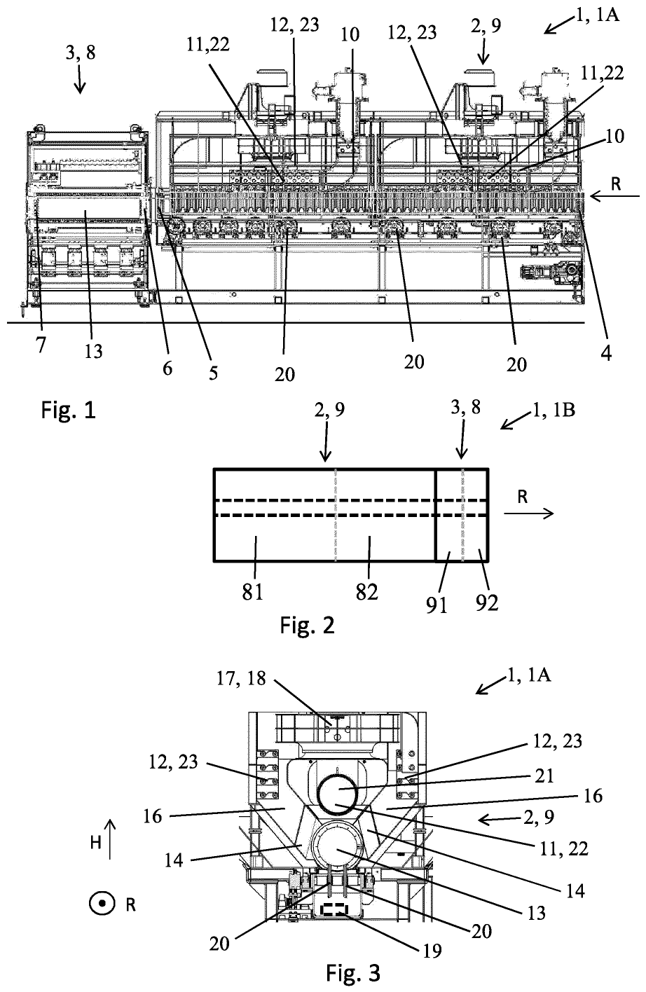

FIG. 1 is a lateral perspective view of a preferred first embodiment 1A of a heating device 1 according to the invention for heating rod-shaped, electroconductive workpieces 13, which can be conveyed along a conveying direction R through the heating device 1 according to the invention to conduct the heating.

Heating device 1 according to the invention comprises a first heating module 2 and a second heating module 3. First heating module 2 has a first input area 4 and a first output area 5 and the second heating module 3 comprises a second input area 6 and a second output area 7.

Second heating module 3 is configured as an induction module 8 in order to heat electroconductive workpiece 13 via eddy currents which can be generated by means of power coils which can be supplied with electricity as a result of generated magnetic fields. The power coils concentrically surround workpiece 13 to be heated (material to be heated), a magnetic field which varies with time being generatable by the power coils in order to generate the eddy currents required for heating in metallic workpiece 13.

The power coils are either induction coils which can be supplied with an alternating current, or, preferably, rotating permanent magnets. The permanent magnets, which are disposed around workpiece 13 to be heated, can be rotationally moved either directly as a rotor or indirectly via a belt drive in order to generate the magnetic field which varies with time.

First heating module 2 is configured as a convection module 9 having heating mediums 10 (not shown in detail); convection module 9 being designed such that a working gas can circulate between heating mediums 10 and workpiece 13 to be received and to be heated, the working gas initially being heated when flowing through heating mediums 10 and, subsequently, the working gas realizing a heat input into workpiece 13 by flowing against workpiece 13. Convection module 9 of the first embodiment is set-up modularly and comprises two heating zones which each comprise heating mediums 10 and which can be operated independently of each other.

In the present embodiment, heating mediums 10 comprise both a gas burner 11, in order to allow a heating of the working gas by burning a gaseous fuel, and an electrical resistance heating element 12 (not shown in detail), which is formed by a resistance-heated resistance register 23 in the present embodiment and which allows heating the working gas by converting electric energy to thermal energy.

Furthermore, the graphical representation shows that first output area 5 is structurally disposed directly on second input area 6, which is the reason for the compact design of heating device 1 according to the invention with respect to the length in conveying direction R. Advantageously, flame formation does not occur when workpiece 13 is heated by means of convection module 9, which is why a decoupling portion—such as is known from the generic state of the art—is not required.

During operation, rod-shaped workpieces 13 to be heated are introduced into heating device 1 through first input area 4 and by means of handling means, which are designed as rolls 20 in the present case, transported along conveying direction R through first output area 5 into second heating module 3, which is disposed directly behind. Advantageously, heating device 1 according to the invention allows a preheating of workpieces 13, said preheating being realized by convection module 8, to a temperature between 380° ° C. to 450° C. by means of the circulating working gas, which is periodically heated to a temperature within the range of 730° C. to 750° C. by means of heating mediums 10. Subsequently, workpiece 13 is further heated in induction module 9 using a high performance in order to heat the workpiece to a final temperature between 500° C. to 560° C. or, preferably, to a final temperature of up to 1000° C.

If workpiece 13 comprises an aluminum alloy, it is preferred that the final temperature is within the range of 500° C. to 560° C. after passing through induction module. Alternatively, workpiece 13 can also comprise another non-ferrous metal, in particular copper or a copper alloy, although it is preferred in this context if the preheating is carried out to a temperature within the range of 580° ° C. to 600° C. and the final temperature after passing through induction module 9 is between 700° C. to 1000° C.

FIG. 2 shows a heavily schematized side view of heating device 1 according to the invention according to a second preferred embodiment 1B. The illustration clarifies that heating device 1 has a modular design with respect to conveying direction R. Thus, first heating module 2 comprises two heating zones at first, the first heating zone being formed by a first convection module 81 and the second heating zone being formed by a second convection module 82, which are disposed directly adjacent to each other. Advantageously, the temperature in first convection module 81 can be adjusted independent of the temperature in second convection module 82.

Furthermore, induction module 8 is also divided into individually controllable zones which are formed by a first induction module 91 and a second induction module 92. Advantageously, dividing heating device 1 into different controllable zones allows realizing axial temperature profiles in order to be able to heat rod-shaped workpiece 13 individually.

FIG. 3 shows a cross section of heating device 1 according to the invention according to first embodiment 1A known from FIG. 1 in the area of first heating module 2. The illustration shows rod-shaped workpiece 13 which is to be heated when passing through heating device 1 and which comprises a circular cross section and which is mounted on several rolls 20, which form the handling means, in order to pass through heating device 1 translationally along conveying direction R.

With respect to a vertical direction H of heating device 1 above workpiece 13, a steel tube 21 having lateral openings 24 (not shown) is disposed, which is a component of gas burner 11, which is a recuperative burner 22 in this case, in order to heat the working gas or to at least partly generate the working gas from the combustion air.

With respect to vertical direction H above steel tube 21, gas-conveying elements 17 are disposed, which are formed by a fan 18 in the present case and which partly suction the combustion air for forming the working gas from steel tube 21 in vertical direction H in order to then conduct the working gas via ventilation ducts 16 which are provided laterally opposite each other and which are disposed mirror-symmetrically on both sides of workpiece 13.

Ventilation ducts 16 are disposed and formed such that the working gas flows through electrical resistance heating element 12 for alternatively or additionally heating the working gas by means of electric energy. In other words, electrical resistance heating element 12, which is configured as a resistance-heated heating register 23 in the present case, is located between gas-conveying elements 17 and workpiece 13 to be subjected to the working gas or to be heated in relation to the flow path of the working gas.

At the end of ventilation ducts 16, nozzle elements 14 are formed in order to optimize the average flow rate of the working gas when it flows against workpiece 13 to be heated during active operation of heating device 1 according to the invention for a high heat input.

During operation of heating device 1 according to the invention, the combustion air in the area of steel tube 21 reaches approximately 1000° C. The combustion air is sucked in by gas-conveying elements 17 and conveyed along ventilation ducts 16 via electrical resistance heating element 12 onto workpiece 13, an average flow rate of up to 50 m/s being realizable by nozzle elements 14. Thus, in an operating mode of heating device 1 according to the invention, a first operating mode is realized by a control unit 19 (not shown in detail), in which the working gas is generated and heated by means of gas burner 11.

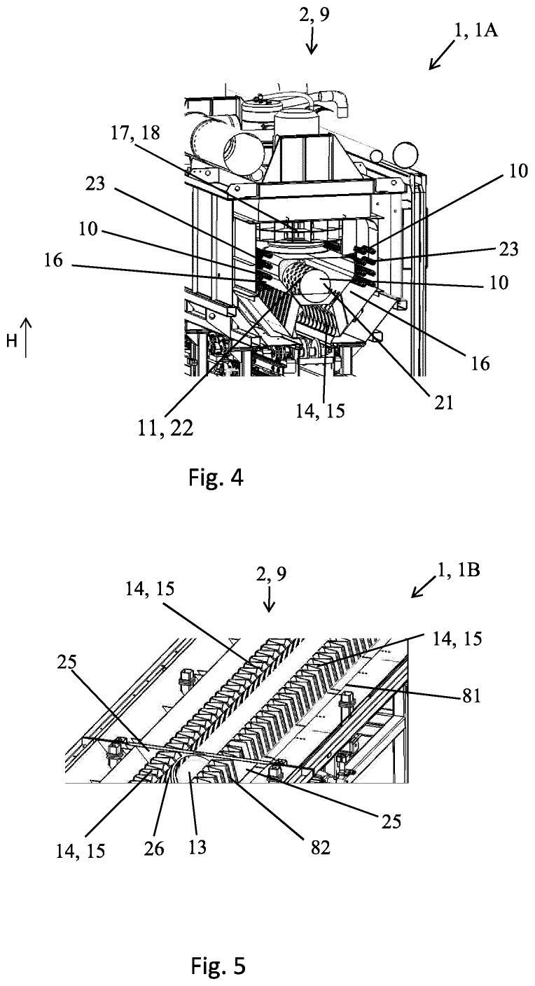

FIG. 4 is a perspective sectional view of heating device 1 known from FIG. 1 according to first embodiment 1A. The sectional view shows sections of first heating module 2 of heating device 1 according to the invention, said first heating module 2 being formed by convection module 9 having hybrid heating mediums 10.

The illustration shows that gas burner 11, which is configured as recuperative burner 22, extends along conveying direction R over accommodatable rod-shaped workpiece 13. Furthermore, openings 24, which are laterally formed in steel tube 21, are visible, from which the gasses resulting from the combustion process escape as hot combustion air for forming the working gas, which are then sucked in by gas-conveying elements 17 in vertical direction H.

Via laterally formed ventilation ducts 16, the working gas flows over resistance-heated resistance heating register 23, which is disposed on both sides, onto workpiece 13, whereby it is now apparent that nozzle elements 14 formed at the end of ventilation ducts 16 are configured as a plurality of slot nozzles 15, which are disposed on the circumference of accommodatable workpiece 13 and which cause an increase in the average flow rate of the working gas when the working gas flows against workpiece 13 in order to optimize the heat input into workpiece 13.

FIG. 5 is another perspective view of heating device 1 according to the invention according to second embodiment 1B.

In addition to rod-shaped workpiece 13 to be heated, which is passing through first heating module 2 and against which the heated working gas, which has previously been heated via heating mediums 10 (now shown) thus flows, the illustration also shows the plurality of slot nozzles 15, which realize an optimal heat input into workpiece 13.

Slot nozzles 15 are disposed in sections laterally to rod-shaped workpiece 13 in order to realize that the working gas flows against the lateral surface of workpiece 13 in an essentially radial manner.

Each slot nozzle 15 is formed by a pair of metal sheets disposed in a V-shape to each other, an arc-shaped recess 26 being formed in the tapered area for accommodating rod-shaped workpiece 13.

Advantageously, the plurality of slot nozzles 15 synergistically allows the total length of heating device 1 according to the invention to be shortened because the heat input into rod-shaped workpiece 13 can be improved.

Furthermore, it can be seen that illustrated first heating module 2 comprises at least two heating zones having a first convection module 81 and at least a second convection module 82, which are separated from each other by means of a separating element 25. Advantageously, this allows implementing an axial temperature profile in order to allow adjusting the heating process for different material compositions of rod-shaped workpiece 13.

### REFERENCE SIGNS

1 heating device
1A heating device according to a first embodiment
1B heating device according to a second embodiment
2 first heating module
3 second heating module
4 first input area
5 first output area
6 second input area
7 second output area
8 induction module
9 convection module
10 heating mediums
11 gas burner
12 electrical resistance heating element
13 workpieces
14 nozzle elements
15 slot nozzle
16 ventilation duct
17 gas-conveying elements
18 fan
19 control unit
20 rolls
21 steel tube
22 recuperative burner
23 electrical resistance heating element
24 openings
25 separating element
26 recess
81 first convection module
82 second convection module
91 first induction module
92 second induction module
R conveying direction
L longitudinal axis
H vertical direction

1. A heating device (1) for heating rod-shaped, electroconductive workpieces (13) which are conveyed along a conveying direction (R) through the heating device (1), said heating device (1) comprising a first heating module (2) in relation to the conveying direction (R), the first heating module (2) having a first input area (4) and a first output area (5), and a second heating module (3) in relation to the conveying direction (R), the second heating module (3) having a second input area (6) and a second output area (7), the second heating module (3) being configured as an induction module (8),
wherein
the first heating module (2) is configured as a convection module (9) having heating mediums (10), the convection module (9) being designed and configured such that for heating the workpiece (13), a working gas circulates between the heating mediums (10) and the workpiece (13) to be heated, in such a manner that the working gas is initially heated by the heating mediums (10) and then, the heated working gas flows against the workpiece (13), and wherein the first output area (5) is structurally disposed directly on the second input area (6).

2. The heating device according to claim 1,
wherein
the heating mediums (10) comprise a gas burner (11) and an electrical resistance heating element (12).

3. The heating device according to claim 1,
wherein
the convection module (9) comprises at least one ventilation duct (16) for guiding the working gas between the heating mediums (10) and the workpiece (13) to be heated.

4. The heating device according to claim 1,
wherein
the convection module (9) comprises gas-conveying elements (17) for controlling and/or affecting an average flow rate of the working gas.

5. The heating device according to claim 1,
wherein
the convection module (9) comprises a control unit (19) for controlling and/or activating an operating mode of the gas burner (11) and/or of the electrical resistance heating element (12), the control unit (19) being formed and/or configured such that, depending on user-generated and/or parameter-generated input signals, only the gas burner (11) is activable in a first operating mode, only the electrical resistance heating element (12) is activable in a second operating mode, and the gas burner (11) and the electrical resistance heating element (12) are activable in a third operating mode.

6. The heating device according to claim 1,
wherein
the convection module (9) comprises nozzle elements (14) for affecting the flow rate of the working gas when it strikes the rod-shaped workpiece (13).

7. The heating device according to claim 6,
wherein
the nozzle elements (14) are configured as a plurality of slot nozzles (15) which are disposed adjacent to each other in the conveying direction (R) and which extend laterally the rod-shaped workpiece (13) to be conveyed.

8. The heating device according to claim 1,
wherein
the first heating module (2) comprises at least two heating zones having a first convection module (81) and at least a second convection module (82).

9. The heating device according claim 1,
wherein
the induction module (8) comprises at least two independently controllable heating zones having a first induction module (91) and at least a second induction module (92).

10. The heating device according to claim 1,
wherein
the first heating module (2) and the second heating module (3) are formed such that the conveying direction (R) in the first heating module (2) and the conveying direction (R) in the second heating module (3) extend along a shared longitudinal axis (L).

11. The heating device according to claim 1,
wherein
the first heating module (2) comprises a length between 6 m to 15 m in the conveying direction (R), and the second heating module (3) comprises a length between 0.5 m to 4 m in the conveying direction (R).

12. The heating device according to claim 1, wherein the heating device is an in-line heater.

13. The heating device according to claim 1, wherein the rod-shaped, electroconductive workpieces (13) are metal rods and/or non-ferrous metal rods.

14. The heating device according to claim 2, wherein the gas burner (11) is a recuperative burner (22) and wherein the electrical resistance heating element (12) is a resistance-heated heating register.

15. The heating device according to claim 4, wherein the gas-conveying elements (17) are a ventilator or a fan (18), and wherein the average flow rate of the working gas is in the at least one ventilation duct (16).

16. The heating device according to claim 7, wherein the plurality of slot nozzles (15) extend laterally in sections to the rod-shaped workpiece (13) to be conveyed.

17. The heating device according to claim 11, wherein the first heating module (2) comprises a length between 6 m to 12 m, and wherein the second heating module (3) comprises a length between 0.8 m to 2 m.

18. The heating device according to claim 11, wherein the first heating module (2) comprises a length between 6 m to 10 m, and wherein the second heating module (3) comprises a length between 0.8 m to 1.6 m.
